(19) United States
(12) Patent Application Publication
(10) Pub. No.: US 2024/0322257 A1
(43) Pub. Date: Sep. 26, 2024

(54) INORGANIC ADDITIVE TO TRAP TRANSITION METAL IONS IN SODIUM ION BATTERIES

(71) Applicant: SPECIALTY OPERATIONS FRANCE, Lyon (FR)

(72) Inventors: Marc-David Braida, Bry-Sur-Marne (FR); Florent Leclercq, Cachan (FR)

(73) Assignee: SPECIALTY OPERATIONS FRANCE, Lyon (FR)

(21) Appl. No.: 18/576,269

(22) PCT Filed: Jul. 5, 2023
(86) PCT No.: PCT/EP2022/068498

§ 371 Date: Jan. 3, 2024

(30) Foreign Application Priority Data
Jul. 7, 2021 (EP) 21315123.6

(51) Int. Cl. H01M 10/42; H01M 4/02; H01M 4/58; H01M 4/587; H01M 10/054; H01M 10/0567; H01M 10/0568

(52) U.S. Cl. CPC H01M 10/4235; H01M 4/5825; H01M 4/587; H01M 10/054; H01M 10/0567; H01M 10/0568; H01M 2004/027; H01M 2004/028; H01M 2300/0025

(57) ABSTRACT

Inorganic additive to trap transition metal ions in sodium ion batteries The present invention relates to a sodium ion battery comprising an inorganic transition metal cations trap such as hydroxyapatite. It also relates to a positive electrode, a negative electrode, an electrolyte and a separator comprising said inorganic transition metal cations trap.

This application claims priority filed on 7 Jul. 2021 in EUROPE with Nr 21315123.6, the whole content of this application being incorporated herein by reference for all purposes.

The present invention relates to a sodium ion battery comprising an inorganic transition metal cations trap such as hydroxyapatite. It also relates to a positive electrode, a negative electrode, an electrolyte and a separator comprising said inorganic transition metal cations trap.

### TECHNICAL BACKGROUND

The demand for lithium-ion batteries has increased in recent years with regard to their application in a wide variety of electronic devices, such as portable telephones and electric vehicles. In point of fact, lithium-based compounds are relatively expensive and natural lithium sources are unequally distributed over the planet and are not readily accessible as they are localized in a small number of countries. Alternatives to this element have thus been sought. To this end, sodium-ion batteries have been developed. This is because sodium is very abundant and distributed homogeneously, and is advantageously nontoxic and economically more advantageous.

A sodium ion battery generally operates by reversibly passing sodium ions between a negative electrode (anode) and a positive electrode (cathode). The negative and positive electrodes are generally situated on opposite sides of a porous separator soaked with an electrolyte composition suitable for conducting sodium ions. Each electrode is associated with a current collector. The current collectors are connected in an external circuit that allows an electric current to flow between the electrodes to balance the related migration of the sodium ions.

### The Technical Problem

Dissolution of transition metal cations from the positive electrode in the electrolyte composition is a problem encountered by a large variety of high voltage electrode materials in alkaline-ion batteries technology and particularly in sodium ion batteries technology. This phenomenon is detrimental because of the migration of the cations at the anode side and its interference with SEI construction. It is a major point of attention which requires contingency measures such as electrolyte modifications to decrease solubility of selected cations, or modification of the surface of the active materials or the use of ion selective membranes as separator.

WO2021/073467A1 discloses a sodium-ion battery wherein the positive active material is doped with low-valence inactive transition metal Li⁺. During charge and discharge, effective ingredients in electrolytic solution interact with Li⁺ ions to form a stable cathode electrolyte interface (CEI) film to suppress dissolution of other transition metal ions of the positive active material.

US2019/296305A1 discloses cation exchangers suitable for metal adsorption for non aqueous electrolyte lithium battery.

In sodium ion batteries, depending on the nature of the positive electrode material, different transition metal cations are expected to undergo dissolution. Just as a matter of example, vanadium cations (V²⁺, V³⁺, V⁴⁺ or V⁵⁺) dissolution is generally observed during the cycling of sodium fluorophosphates (NVPF)/Hard carbon cells, which degrades the battery performance by depositing on the negative electrode.

There is a need for preventing the dissolution of transition metal cations from positive electrode in sodium ion batteries. There is also a need for preventing the migration of said transition metal cations from positive electrode towards negative electrode. Finally, there is a need for preventing the deposition of said transition metal cations on negative electrode which is detrimental to solid electrolyte interface (SEI) construction.

All these needs and others are fulfilled by providing a sodium ion battery comprising:
a positive electrode;
a negative electrode;
a separator;
an electrolyte composition; and
an inorganic transition metal cations trap.

### Definitions

Throughout this specification, unless the context requires otherwise, the word “comprise” or “include”, or variations such as “comprises”, “comprising”, “includes”, including” will be understood to imply the inclusion of a stated element or method step or group of elements or method steps, but not the exclusion of any other element or method step or group of elements or method steps. According to preferred embodiments, the word “comprise” and “include”, and their variations mean “consist exclusively of”.

As used in this specification, the singular forms “a”, “an” and “the” include plural aspects unless the context clearly dictates otherwise. The term “and/or” includes the meanings “and”, “or” and also all the other possible combinations of the elements connected to this term.

The term “between” should be understood as being inclusive of the limits.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of about 120° C. to about 150° C. should be interpreted to include not only the explicitly recited limits of about 120° C. to about 150° C., but also to include sub-ranges, such as 125° C. to 145° C., 130° C. to 150° C., and so forth, as well as individual amounts, including fractional amounts, within the specified ranges, such as 122.2° C., 140.6° C., and 141.3° C., for example.

The term “electrolyte” refers in particular to a material that allows ions, e.g., Na⁺, to migrate therethrough but which does not allow electrons to conduct therethrough. Electrolytes are useful for electrically isolating the cathode and anodes of a battery while allowing ions, e.g., Nat, to transmit through the electrolyte.

As used herein, the terms “cathode” and “anode” refer to the electrodes of a battery. During a charge cycle in a Na-secondary battery, Na ions leave the cathode and move through an electrolyte and to the anode. During a charge cycle, electrons leave the cathode and move through an external circuit to the anode.

During a discharge cycle in a Na-secondary battery, Na ions migrate towards the cathode through an electrolyte and from the anode. During a discharge cycle, electrons leave the anode and move through an external circuit to the cathode.

### THE INVENTION

The invention relates to a sodium ion battery comprising:
a positive electrode;
a negative electrode;
a separator;
an electrolyte composition; and
an inorganic transition metal cations trap;
   wherein the inorganic transition metal cations trap reduces or prevents migration of said transition metal cations to the negative electrode and deposition thereof at or on the negative electrode.

In a second aspect the invention pertains to a positive electrode, a negative electrode, an electrolyte and a separator comprising said inorganic transition metal cations trap.

More details on the invention are now given below, including in the claims.

### Inorganic Transition Metal Cations Trap

As above mentioned, the inorganic transition metal cations trap reduces or prevents migration of said transition metal cations to the negative electrode and deposition thereof at or on the negative electrode.

The inorganic transition metal cations trap is generally selected from calcium phosphates. In some embodiments, the inorganic transition metal cations trap is selected from tricalcium phosphate Ca₃(PO₄)₂, octacalcium phosphate Ca₈H₂(PO₄)₆, dicalcium diphosphate Ca₂P₂O₇, calcium triphosphate Ca₅(P₃O₁₀)₂, tetracalcium phosphate Ca₄(PO₄)₂O, apatite Ca₁₀(PO₄)₆(OH, F, Cl, Br)₂, hydroxyapatites (HAP) and mixtures thereof.

Without being bound to any theory calcium phosphate is thought to be an effective trap for various transition metal species in the form of metal cations or in the form of metal cations containing compounds. More than one metal trapping mechanism can be expected such as ion-exchange, involving the substitution of either Ca(I) or Ca(II) ions of the calcium phosphate framework, surface complexation, and dissolution-precipitation of new formed stable phosphate containing phases.

In some embodiments the inorganic transition metal cations trap is selected from hydroxyapatite (HAP). HAP is of general formula Ca₁₀(PO₄)₆OH₂ with a molar Ca/P ratio of 1.67 (stoichiometry) but has a very flexible structure in which other metal cations can substitute in part for Ca²⁺ and other anionic species can substitute in part for phosphate and/or for hydroxyl anions. As a result of these possible substitutions, the Ca/P ratio can change and the Ca/P ratio is typically ranging from 1.50 to 2.08 depending on the method of production. For example, carbonate groups can insert in the hydroxyapatite structure by replacing phosphate and/or hydroxyl groups to form carbonated hydroxyapatite. Hence, when replacing phosphate groups, carbonate groups contribute to HAP with Ca/P ratio above 1.67.

In some embodiments, the inorganic transition metal cations trap is selected from hydroxyapatites having a Ca/P ratio ranging from 1.50 to 2.00.

In some preferred embodiments the inorganic transition metal cations trap is selected from hydroxyapatites having a Ca/P ratio ranging from 1.50 to 1.80.

In some more preferred embodiments the inorganic transition metal cations trap is selected from hydroxyapatites having a Ca/P ratio ranging from 1.50 to 1.67.

In some even more preferred embodiments the inorganic transition metal cations trap is hydroxyapatite having a molar Ca/P ratio of 1.60.

Naturally-derived HAP of various qualities are recovered after calcination and treatment of bones such as fish bones, cow bones (containing a large quantity of HAP). The main impurities are carbon and calcium carbonate, and such naturally-derived HAP are called bone char. The Ca/P ratio of bone char is generally below 1.67. There exist different grades of bone chars, some being subjected to post-treatments after calcination to reduce the impurities amount.

Synthetic HAP can be synthesized by several ways generally classified into dry, wet and high temperature methods.

The dry methods include solid state syntheses and mechanochemical syntheses.

Solid state reaction implies decomposition reaction of mixed solid reactants by heating producing new solids and gazes. The solid state method for preparing HAP generally involves chemical precursors containing calcium and phosphate that are milled and calcined. HAP synthesis can be performed through the reaction at high temperature (approximately 1000° C.) between e.g. CaO and P₂O₅, CaHPO₄ and CaO, Ca₃(PO₄)₂ and Ca(OH)₂, CaHPO₄ and CaCO₃ or CaCO₃ and NH₄H₂PO₄. Mechanochemical synthesis consists in inducing chemical reaction through compression, shear or friction via grinding and milling of reactants. HAP synthesis can be performed through the mechanochemical method involving e.g. CaO and P₂O₅, Ca₃(PO₄)₂ and Ca(OH)₂, Ca₂P₂O₇ and CaCO₃ or CaHPO₄·2H₂O, urea and CaCO₃.

Wet chemical production method can be performed by precipitation methods e.g. by reacting calcium hydroxide and orthophosphoric acid through addition of the acid to a dilute solution/suspension of the hydroxide at a pH greater than 9. The hydroxyapatite is also recovered by precipitation during the reaction between calcium nitrate or calcium chloride, diammonium hydrogen phosphate and ammonium hydroxide as pH regulator. Processing at pH lower than 9 can result in the production of calcium deficient hydroxyapatite i.e. with a Ca/P ratio below the stoichiometric ratio of 1.67. Recovered precipitated powder is generally calcined between 400° C. and 600° C. or higher to obtain stoichiometric hydroxyapatite. The morphological properties (shape and size), stoichiometry, specific surface area and degree of crystallinity of the synthesized HAP through precipitation are greatly affected by the synthesis parameters such as temperature, time, reagent addition rate, calcination, pH, and use of different reagents and their purity.

Another wet chemical production method is called Hydrothermal method. The Hydrothermal methods for synthesising HAP use high temperature and pressure to stimulate a reaction in aqueous media containing calcium and phosphate precursors. The hydrothermal methods can be perform e.g. using CaCO₃, Ca(OH)₂ or Ca(NO₃)₂·4H₂O and (NH₄)₂(HPO₄) at high temperatures and pressures. Generally calcium, phosphate, and/or alkaline sources amounts are set to control the Ca/P ratio of the products.

HAP can also be prepared by high temperature methods including combustion spray pyrolysis techniques.

Combustion method uses rapid exothermic and self sustaining redox reaction between an oxidant and an organic fuel in an aqueous phase. Just for the sake of example calcium nitrate or calcium acetate and diammonium hydrogen phosphate can be used respectively as calcium and phosphate sources while citric acid, succinic acids and urea can be used as fuels. Combustion method can produce highly crystalline HAP generally accompanied with other phase impurity.

Spray pyrolysis consists in spraying precursor solutions into a flame of a hot zone of an electric furnace. Precursors are for example Ca₃(PO₄)₂, Ca(NO₃)₂·4H₂O and (NH₄)₂HPO₄; Ca(C₂H₃O₂)₂ (calcium acetate) and (NH₄)₂HPO₄; Ca(NO₃)₂, (NH₄)₂HPO₄ and HNO₃; Ca(OH)₂ and H₃PO₄ or Ca(C₂H₃O₂)₂ and (CH₃)₃PO₄·HAP phase can be produced by spray pyrolysis generally accompanied with other calcium phosphate phase.

HAPs can be crystalline, amorphous or partially crystalline depending on their method of production. When HAP is crystalline, the crystals may have different shapes such as rod-like or platelets. The form of the crystals may impart different properties to the HAP.

HAPs suitable for the present invention can be crystalline, amorphous or partially crystalline. Good results were obtained with crystalline HAP. Generally, HAPs suitable for the present invention have a BET specific surface ranging from 40 m²/g to 200 m²/g; preferably from 40 m²/g to 180 m²/g. Generally, HAPs suitable for the present invention have a D50 size measured by laser diffraction ranging from 5 μm to 100 μm; preferably ranging from 5 to 60 μm. Good results were obtained with crystalline HAP having a specific surface of 166 m²/g and a D50 size of 45 μm.

Besides, examples of synthesis of hydroxyapatites suitable for the invention can be found in WO15173437.

### Positive Electrode

The sodium ion battery according to the invention comprises a positive electrode or cathode comprising a electrochemically active cathode material, which determines the cell voltage and capacity and thereby the energy density of the sodium ion battery and which is a sodium ion conductive material, at least one electron-conducting material and optionally a binder.

The electrochemically active cathode materials are generally selected from Na-based layered transition-metal oxides, Prussian blue analogs and polyanion-type materials.

In some embodiments the electrochemically active cathode materials are Na-based layered transition-metal oxides classified as O3-, P2-, and P3-types depending on the stacking sequence of oxygen layers. P2-type structures generally respond to the general formula NaxMO₂ wherein M stands for a transition metal ion such as Co, Mn and x is ⅔.

In some embodiments the electrochemically active cathode materials are Prussian blue analogs (PBA) of general formula AₓP[R(CN)₆]_{1-y□y}·mH₂O with A and alkali metal ion, P a N-coordinated transition metal ion, R a C-coordinated transition metal ion, □ a [R(CN)₆] vacancy, with 0≤x≤2 and 0≤y<1 such as Na_{0.81}Fe[Fe(CN)₆]_{0.79□0.21}, NaFe₂(CN)₆, Na_{1.63}Fe_{1.89}(CN)₆, Na_{1.72}MnFe(CN)₆, Na_{1.76}Ni_{0.12}Mn_{0.88}[Fe(CN)₆]_{0.98}, Na₂NiₓCO₁₋ₓFe(CN)₆ with 0≤x≤1 e.g. Na₂CoFe(CN)₆.

In some other embodiments the electrochemically active cathode materials are polyanion-type materials of general formula NaₓM_{y}(XO₄)ₙ (where X=S, P, Si, As, Mo and W and M is transition metal), which possess a series of tetrahedron anion units (XO₄)ⁿ⁻ and their derivatives (XₘO₃ₘ₊₁)ⁿ⁻. Among them, phosphates NaMPO₄ such as NaFePO₄, Na_{0.7}FePO₄ or NaMnPO₄; natrium (sodium) superionic conductor of NASICON-type structures of general formula NaₓM₂(XO₄)₃ (where 1≤x<4 and M=V, Fe, Ni, Mn, Ti, Cr, Zr . . . ; X=P, S, Si, Se, Mo . . . )—with single transition metal type such as Na₃V₂(PO₄)₃ (NVP), Na₃Cr₂(PO₄)₃, Na₃Fe₂(PO₄)₃;—with binary transition metal type such as Na₂VTi(PO₄)₃, Na₃FeV(PO₄)₃, Na₄MnV(PO₄)₃, Na₃MnZr(PO₄)₃, Na₃MnTi(PO₄)₃, Na₄Fe₃(PO₄)₂(P₂O₇) (NFPP); pyrophosphates Na₂FeP₂O₇, Na₂MnP₂O₇, Na₂CoP₂O₇, Na₄₋ₓFe_{2+x/2}(P₂O₇)₂ with ⅔≤x≤⅞ e.g. Na_{3.12}Fe_{2.44}(P₂O₇)₂ or Na_{3.32}Fe_{2.34}(P₂O₇)₂, Na₂(VO)P₂O₇, Na₇V₃(P₂O₇)₄; fluorophosphates NaVPO₄F, Na₂CoPO₄F, Na₂FePO₄F, Na₂MnPO₄F, Na₃(VO₁₋ₓPO₄)₂F₁₊₂ₓ (with 0≤x≤1) e.g. Na₃(VOPO₄)₂F or Na₃V₂(PO₄)₂F₃ (NVPF); fluoro Fe, Co, Ni); mixed sulfates as NaMSO₄F (with M=such phosphates/pyrophosphates of general formula Na₄M₃(PO₄)₂(P₂O₇) (with M representing transition metals) such as Na₄Mn₃(PO₄)₂(P₂O₇), Na₄Co₃(PO₄)₂(P₂O₇), Na₄Ni₃(PO₄)₂(P₂O₇), Na₄Fe₃(PO₄)₂(P₂O₇) (NFPP), Na₇V₄(P₂O₇)₄(PO₄); sulfates such as Na₂Fe₂(SO₄)₃, Na₂₊₂ₓFe₂₋ₓ(SO₄)₃, Na₂₊₂ₓCO₂₋ₓ(SO₄)₃, Na₂₊₂ₓMn₂₋ₓ(SO₄)₃ (where 0≤x<1); silicates of general formula Na₂MSiO₄ (with M=Mn, Fe, Co and Ni).

In some preferred embodiments the electrochemically active cathode materials are fluorophosphates preferably selected from the list consisting of NaVPO₄F, Na₂CoPO₄F, Na₂FePO₄F, Na₂MnPO₄F, Na₃(VO₁₋ₓPO₄)₂F₁₊₂ₓ (with 0≤ x≤1) e.g. Na₃(VOPO₄)₂F or Na₃V₂(PO₄)₂F₃ (NVPF).

Good results were obtained with the electrochemically active cathode material being Na₃V₂(PO₄)₂F₃ (NVPF). In NVPF compound of molecular formula Na₃V₂(PO₄)₂F₃, vanadium is present in the +II oxidation state. The NVPF may be partially oxidized. In this case, the product is characterized by the presence also of vanadium in the +IV oxidation state as well as by the partial replacement of fluorine atoms by oxygen atoms. The partially oxidized NVPF may be represented by the formula Na₃V₂(PO₄)₂F₃₋ₓOₓ, x being an integer between 0 and 2. These electrochemically active cathode materials can be doped with heteroelements (Fe, Ti, Co, Ni, Mn, Zr . . . ).

The positive electrode also comprises at least one electron-conducting material that may be chosen from carbon fibers, carbon black, carbon nanotubes, graphene and their analogs. An example of conductive material is Super P carbon, for example H 30253, sold by Alfa Aesar. The positive electrode optionally comprises a binder that may advantageously be a polymer. The binder may advantageously be chosen from polytetrafluoroethylene, polyvinylidene fluoride or a copolymer of vinylidene fluoride and of at least one comonomer, such as, for example, derived from carboxymethylcellulose, hexafluoropropylene, polymers polysaccharides and latexes, in particular of styrene/butadiene rubber type. The binder is preferably a copolymer of vinylidene fluoride and of at least one comonomer, such as, for example, hexafluoropropylene. It may, for example, be the Solef® 5130 grade sold by Solvay.

The positive electrode composition may comprise from 70.0% to 97.0% by weight of the electrochemically active cathode material, from 1.5% to 15.0% by weight of the electron-conducting material and from 1.5% to 15.0% by weight of binder.

### Negative Electrode

The sodium ion battery according to the invention comprises a negative electrode or anode comprising suitable electrochemically active anode material optionally one electron-conducting material and optionally a binder.

Generally the electrochemically active anode material is selected from carbon based materials, conversion conversion/alloying compounds and alloying compounds.

In some other embodiments the electrochemically active anode materials are carbon based materials selected from expanded graphite, non-graphitic carbon such as soft carbon which is graphitizable carbon that can be obtained from liquid or gas phase pyrolysis or hard carbon which is non-graphitizable carbon formed by the solid-phase pyrolysis of cellulose, charcoal, coal, sugar or carbon nanomaterials such as carbon nanotubes, graphene or carbon nanofibers, and metal organic framework (MOFs) based carbon materials.

In some other embodiments the electrochemically active anode materials are conversion conversion/alloying materials which undergo conversion of metal oxide or sulphide to some new compound through chemical transformation. Suitable metal oxides are Fe₃O₄, SnO₂, SnO, CuO, Co₃O₄, MoO₃, MnO₂, TiO₂, NiO, MnO, Suitable metal sulphides are MOS₂, ZnS, SnS₂, FeS, CuS, Sb₂S₃, Co₃S₄, NiS, MoS, WS₂, Suitable metal selenides are Sb₃Se₃, MoSe₂, FeSe₂, ZnSe, NiSe. Suitable metal phosphides are Se₄P₄, Sn₄P₃, CoP, FeP, MoP, CuP₂.

In some other embodiments the electrochemically active anode materials are alloying materials which are elements that can form alloy with sodium. Suitable alloying materials are generally selected from elements of group 14 and 15 such as Si, Ge, Sn, Pb, P, Sb, Bi and mixtures thereof. Said alloying materials may be mixed with inactive elements such as Co, Ni, Zn, Mo, Cu, Ti, Te or F.

In some other embodiments the electrochemically active anode materials are organic materials such as conjugated carboxylate organic compounds, Schiff base polymers, polyamides, polyquinones or conjugated polymers.

Good results were obtained with the electrochemically active anode material being hard carbon.

Good results were obtained with the electrochemically active cathode material being Na₃V₂(PO₄)₂F₃ (NVPF) and the electrochemically active anode material being hard carbon.

The electron-conducting material may be chosen from carbon fibers, carbon black, carbon nanotubes, graphene and their analogs. An example of conductive material is Super P carbon, for example H 30253, sold by Alfa Aesar. The binder may advantageously be a polymer. The binder may advantageously be chosen from polytetrafluoroethylene, polyvinylidene fluoride or a copolymer of vinylidene fluoride and of at least one comonomer, such as, for example, hexafluoropropylene, polymers derived from carboxymethylcellulose (CMC), polysaccharides and latexes, in particular of styrene/butadiene rubber (SBR) type.

The binder is preferably a copolymer of vinylidene fluoride and of at least one comonomer, such as, for example, hexafluoropropylene. It may, for example, be the Solef® 5130 grade sold by Solvay.

The negative electrode composition may comprise from 70.0% to 98.0% by weight of the electrochemically active anode material, from 0.0% to 15.0% by weight of the electron-conducting material and from 1% to 15.0% by weight of binder.

### Separator

Separators useful for sodium ion batteries generally consist of highly porous polymeric membrane comprising polypropylene, polyethylene, PVDF, metal oxide (SiO₂, Al₂O₃) coated polypropylene or polyethylene, modified cellulose acetate or non-woven fabric mat. Non-woven glass fiber fabric mat and barium titinate based polymer ceramic membrane may also be used.

Good results where obtained with non-woven glass fiber fabric separator (Whatman® GF6).

Good results were obtained with the electrochemically active cathode material being Na₃V₂(PO₄)₂F₃ (NVPF), the electrochemically active anode material being hard carbon and non-woven glass fiber fabric separator (Whatman® GF6).

### Electrolyte Composition

Electrolyte composition is the contact medium between cathode and anode facilitating ion transport through a porous separator. The electrolyte composition contains enough ions for charge transfer reaction while providing electrical insulation. The electrolyte composition may be either liquid, gelled or solid.

In some embodiments the electrolyte composition is liquid and comprises salts dissolved in an organic solvent. Just for the matter of example, suitable salts are NaBF₄, sodium triflate (NaTF), sodium bis(trifluoromethanesulfonyl)imide (NaTFSI), sodium bis(fluorosulfonyl)imide (NaFSI), sodium 4,5-dicyano-2-(trifluoromethyl)imidazole (NaTDI), NaPF₆, NaClO₄ or mixtures thereof. Good results were obtained with electrolyte composition comprising NaPF₆.

Still for matter of example, suitable organic solvents are non-fluorinated cyclic carbonates such as ethylene carbonate, propylene carbonate, vinylene carbonate or vinyl ethylene carbonate, fluorinated cyclic carbonates such as fluoroethylene carbonate, non-fluorinated acyclic carbonates such as methyl ethyl carbonate, diethyl carbonate or dimethyl carbonate and mixtures thereof. Without being exhaustive the electrolyte composition may also comprise some other solvents such as diglyme, triglyme, fluorinated carbonates, fluorinated ethers, hydrofluorinated ethers or fluorinated esters.

Good results were obtained with electrolyte composition comprising a mixture of ethylene carbonate and dimethyl carbonate.

Good results were obtained with the electrochemically active cathode material being Na₃V₂(PO₄)₂F₃ (NVPF), the electrochemically active anode material being hard carbon, non-woven glass fiber fabric separator (Whatman® GF6) and with electrolyte composition comprising NaPF₆ and a mixture of ethylene carbonate and dimethyl carbonate.

### Incorporation of the Inorganic Transition Metal Cations Trap

The inorganic transition metal cations trap according to the invention can be incorporated in the sodium ion battery in the cathode, in the anode, in the separator, in the electrolyte composition or in any combination of them.

In some embodiments the inorganic transition metal cations trap is incorporated in the cathode by any means known by the skilled person. For example, incorporation can be made by intimely mixing the transition metal cations trap with the electrochemically active cathode material before adding the electron conducting material and optionally a binder. Still for the sake of example, hydroxyapatite can be intimely mixed with electrochemically active cathode material before adding the electron conducting material and optionally a binder.

Hydroxyapatite can also be incorporated by mixing it with processing solvent like NMP before adding electrochemically active cathode material in a planetary mixer.

In some embodiments the inorganic transition metal cations trap is incorporated in the anode by any means known by the skilled person. For example, incorporation can be made by intimely mixing the inorganic transition metal cations trap with the electrochemically active anode material before adding the electron conducting material and optionally a binder. Still for the sake of example, hydroxyapatite can be intimely mixed with electrochemically active anode material before adding optionally an electron conducting material and optionally a binder. Hydroxyapatite can also be incorporated by mixing it with processing solvent like NMP before adding electrochemically active cathode material in a planetary mixer.

In some other embodiments the inorganic transition metal cations trap is incorporated in the separator by any means known by the skilled person. For example, by coating the separator with an aqueous suspension of the inorganic transition metal cations trap and further drying. Still for the sake of example, hydroxyapatite can be incorporated in the separator by coating the hydroxyapatite on the separator. Methods used to coat alumina and know by skilled people can be used to perform this coating. Hydroxyapatite can be coated alone, with a polymer or with a polymer and an additional inorganic material such as alumina.

In some other embodiments the inorganic transition metal cations trap is incorporated in the sodium ion battery through addition of a suspension of said transition metal cations trap in the electrolyte composition. For example, hydroxyapatite can be added in the electrolyte composition by mixing its powder with the solvents and then adding the sodium salt or by mixing the powder with the formulated electrolyte.

Still in some other embodiments the inorganic transition metal cations trap is incorporated in the sodium ion battery in the cathode and in the separator.

Still in some other embodiments the inorganic transition metal cations trap is incorporated in the sodium ion battery in the cathode, in the anode and in the separator.

In some other embodiments the inorganic transition metal cations trap is incorporated in the sodium ion battery in the cathode, in the anode, in suspension in the electrolyte composition and in the separator.

The amount of inorganic transition metal cations trap incorporated in the sodium ion battery represents generally from 0.01 wt % to 10% wt of electrochemically active cathode materials.

Generally, the amount of HAP incorporated in the sodium ion battery represents from 0.01 wt % to 20% wt of the electrochemically active cathode materials (eg:NVPF); preferably from 0.1 wt % to 5% wt.

### Transition Metal Cations

According to the above description of electrochemically active cathode materials, transition metal cations susceptible of being dissolved from electrochemically active cathode materials in the electrolyte composition are generally selected from the list consisting of Mn⁴⁺, Mn³⁺, Mn²⁺, Fe²⁺, Fe³⁺, Cr²⁺, Cr³⁺, Co²⁺, Co³⁺, Ni²⁺, Ni³⁺, Mo⁶⁺, Ti⁴⁺, Zr⁴⁺, V²⁺, V³⁺, V⁴⁺, V⁵⁺ and combinations thereof.

Preferably, transition metal cations susceptible of being dissolved from electrochemically active cathode materials in the electrolyte composition are selected from the list consisting of Mn⁴⁺, Mn³⁺, Mn²⁺, Fe²⁺, Fe³⁺, Cr²⁺, Cr³⁺, Co²⁺, Co³⁺, Ni²⁺, Ni³⁺, V²⁺, V³⁺, V⁴⁺, V⁵⁺ and combinations thereof.

More preferably, transition metal cations susceptible of being dissolved from electrochemically active cathode materials in the electrolyte composition are selected from the list consisting of Fe²⁺, Fe³⁺, Co²⁺, Co³⁺, Ni²⁺, Ni³⁺, V²⁺, V³⁺, V⁴⁺, V⁵⁺ and combinations thereof.

Even more preferably, transition metal cations susceptible of being dissolved from electrochemically active cathode materials in the electrolyte composition are selected from the list consisting of V²⁺, V³⁺, V⁴⁺, V⁵⁺ and combinations thereof.

It is another object of the invention to disclose a positive electrode comprising previously described inorganic transition metal cations trap. The positive electrode of the invention can have all the features of previously described positive electrodes.

It is still another object of the invention to disclose a negative electrode comprising previously described inorganic transition metal cations trap. The negative electrode of the invention can have all the features of previously described negative electrode.

It is another object of the invention to disclose an electrolyte composition comprising previously described inorganic transition metal cations trap. The electrolyte composition of the invention can have all the features of previously described electrolyte composition.

Finally, it is another object of the invention to disclose a separator comprising previously described inorganic transition metal cations trap. The separator of the invention can have all the features of previously described separator.

Should the disclosure of any patents, patent applications, and publications which are incorporated herein by reference conflict with the description of the present application to the extent that it may render a term unclear, the present description shall take precedence.

### EXAMPLES

### Materials

Na₃V₂(PO₄)₂F₃ (NVPF) was synthesized by Solvay according to example 1 of WO2020025638A1.

PVDF was obtained from Solvay Specialty Polymers, grade Solef® 5130.

NaPF₆ was obtained from Sigma Aldrich (purity >99%).

Ethylene carbonate (EC) and dimethyl carbonate (DMC) were purchased from Sigma Aldrich (purity >99%).

Hydroxyapatite was provided by Solvay Soda Ash & Derivatives, grade Capterall® (D50: 45 μm; Specific surface 166 m²/g; Ca/P=1.6). As previously mentioned, examples of synthesis of hydroxyapatites suitable for the invention can be found in WO15173437.

The porosity characteristics of hydroxyapatite were determined after a heat treatment at 110° C. under vacuum overnight (about 16 hours). The BET specific surface area was determined by gas adsorption on a Micromeritics ASAP2020 machine. Before the analysis, the samples (0.7 to 1 g) are pretreated under vacuum at 110° C. until a stable vacuum of 4-5 μbar has been achieved. The measurements were carried out using nitrogen as adsorbent gas at 77° K via the volumetric method, according to the ISO 9277: 2010 standard (Determination of the specific surface area of solids by gas adsorption—BET method). The BET specific surface area was calculated in a relative pressure (P/PO) range varying from around 0.05 to 0.20.

The hydroxyapatite particle size measurement was carried out on a Beckman Coulter LS 230 laser diffraction particle size analyser (laser of wavelength 750 nm) on particles suspended in water and using a size distribution calculation based on Fraunhofer diffraction theory (particles greater than 10 μm) and on Mie scattering theory (particles less than 10 μm), the particles being considered to be spherical. The mean diameter D50 is the diameter such that 50% by weight of the particles have a diameter less than said value.

### Electrodes:

The positive electrode was a formulation of the NVPF (Na₃V₂(PO₄)₂F₃) with carbon black and a PVDF in respective proportions by weight of 94:3:3 with a loading of 12 mg/cm². Aluminum collector (thickness 20 μm) was used for cathode. The hard carbon (HC) electrode was a formulation of hard carbon with carbon black and a PVDF in the same respective proportions by weight of 94:3:3 with a loading of 6 mg/cm². Aluminum collector (thickness 20 μm) was also used for anode.

The electrodes were respectively punched at a 14 mm diameter and 16 mm diameter and dried in Buchi oven at 120° C. for 12 h under vacuum before being used in glovebox ((H₂O<10 ppm, O₂<5 ppm).

### Electrolyte Preparation:

A solution of 1 mol/L NaPF₆ in EC:DMC (1:1, by weight) was prepared in glovebox by introducing 0.84 g of NaPF₆ (white powder) in a 15 mL Nalgene vial and then 5 mL (5.95 g) of a EC:DMC (1:1, by weight) mixture. The solution was manually agitated until complete dissolution of the salt.

### Coin Cell Mounting:

8 CR2032 inox coin cells were prepared in glovebox (H₂O<10 ppm, O₂<5 ppm) using the following components:
one stainless steel spacer (0.5 mm thick),
one NVPF electrode (14 mm diameter),
one glass fiber separator (16 mm diameter, 250 μm thick),
one HC electrode (16 mm diameter),
one stainless steel spacer (1 mm thick),
one spring (1.4 mm thick).

The coin cells were filled with 130 μL of 1 mol/L NaPF₆ in EC:DMC (1:1, by weight) electrolyte and the excess of electrolyte was removed before sealing.

The NVPF electrode was assembled in a full cell configuration, facing hard carbon (HC) negative electrode, in a 2032 (20 mm in diameter by 3.2 mm in thickness) button cell geometry. The button cell consisted of the NVPF positive electrode, of the HC negative electrode, of 100 μl of electrolyte, of a stainless steel spacer with a thickness of 1 mm, of a ring-shaped spring with a thickness of 1.4 mm, of a fiberglass separator with a thickness of 250 μm and of the rigid casing of the cell (two hollow pieces interlocking with a seal). These elements were kept under pressure by the spring inside the rigid casing, which was subsequently crimped in order to guarantee the leak tightness of the system.

### Cycling Conditions:

After 12 h at OCV, the cells were cycled 5 times at C/10 rate (1 C being 128 mA/g_{NVPF}) between 2V and 4.25 V at room temperature on a Biologic MPG 2 potentiostat and then charged at the same C-rate up to 4.25 V. The OCV of the charged cells were all above 4.10 V after the last charge.

### Disassembling of the Cell:

The charged coin cells were opened in glovebox using a Hohsen disassembling tool and the NVPF electrodes were recovered.

Dissolution of Vanadium from the NVPF Electrodes:

The 8 charged NVPF electrodes were recovered and immersed in 20 mL of 1 mol/L NaPF₆ in EC:DMC (1:1, by weight) electrolyte (3.365 g of NaPF₆ in 20 mL (23.59 g) of solvent in a 30 mL Nalgene vial. The 30 mL closed Nalgene vial was sealed with parafilm and put in an oven out of the glovebox at 55° C. for 7 days. After this ageing step, no mass change was detected and the electrolyte has turned green.

### Preparation of HAP Dispersions:

After calendar ageing, the vial was opened in glovebox and the aged electrolyte was divided between 8 Nalgene vials (2.5 mL in each). Two were kept as references and different quantities of hydroxyapatite (Solvay Capterall® provided by Solvay Soda Ash & Derivatives) were added in the others according to table 1. The vials were then sealed again with parafilm.

TABLE 1

| | m electrolyte | m HAP | | Remaining V |
|---|---|---|---|---|
| Sample | (g) | (mg) | wt. % HAP | (ppm by wt.) |
| 1 | 3.220 | 0 | 0 | 85 |
| 2 | 3.218 | 0 | 0 | 86 |
| 3 | 3.218 | 32 | 1 | 29 |
| 4 | 3.245 | 34 | 1 | 28 |
| 5 | 3.221 | 162 | 5 | <2 |
| 6 | 3.211 | 163 | 5 | <2 |
| 7 | 3.226 | 325 | 10 | <2 |
| 8 | 3.214 | 324 | 10 | <2 |

The different dispersions were put under magnetic stirring for 24 h at room temperature out of the glovebox.

### Dosing Method:

After sedimentation of the hydroxyapatite, the supernatant was extracted in glovebox. Vanadium was then dosed by ICP-OES (inductively coupled plasma—optical emission spectrometry) with an Analytic Jena PQ 9000 Elite. Samples were mineralized by microwave (generic reactive method): 8 mL of HNO₃ (67%) was added to approximately 200 mg of supernatant. Samples were then diluted (by mass) in approximately 30 mL of ultrapure water and diluted again (by volume) by half for vanadium dosing.

An external calibration was realized with 0.05/0.1/0.2/0.3 mg/L solutions using 290.881-292.464 nm spectral lines.

Vanadium concentrations were reported by mass. Two test samples were done for each reference and the analysis on these two test samples were repeatable.

The uncertainty was evaluated to 10%.

Results reported in table 1 show that the amount of vanadium species remaining in solution in the electrolyte composition after sedimentation of the hydroxyapatite depends on the amount of hydroxyapatite that was present in the vial. Accordingly, it is clear that hydroxyapatite plays the role of vanadium cations trap when present in contact with the electrolyte composition wherein said cations are dissolved.

1. A sodium ion battery comprising:
a positive electrode;
a negative electrode;
a separator;
an electrolyte composition; and
an inorganic transition metal cations trap.

2. The sodium ion battery according to claim 1, wherein the inorganic transition metal cations trap reduces or prevents migration of said transition metal cations to the negative electrode and deposition thereof at or on the negative electrode.

3. The sodium ion battery according to claim 1, wherein the inorganic transition metal cations trap is selected from calcium phosphates.

4. The sodium ion battery according to claim 3, wherein the inorganic transition metal cations trap is selected from hydroxyapatites having a Ca/P molar ratio ranging from 1.50 to 2.00.

5. The sodium ion battery according to claim 1, wherein the positive electrode comprises Na₃ V₂(PO₄)₂F₃ (NVPF).

6. The sodium ion battery according to claim 1, wherein the negative electrode comprises hard carbon.

7. The sodium ion battery according to claim 1, wherein the electrolyte composition comprises NaPF₆.

8. The sodium ion battery according to claim 1, wherein the inorganic transition metal cations trap is incorporated in the cathode.

9. The sodium ion battery according to claim 1, wherein the inorganic transition metal cations trap is incorporated in the anode.

10. The sodium ion battery according to claim 1, wherein the inorganic transition metal cations trap is incorporated in the electrolyte composition.

11. The sodium ion battery according to claim 1, wherein the inorganic transition metal cations trap is incorporated in the separator.

12. The sodium ion battery according to claim 1, wherein transition metal cations comprises cations from V.

13. An electrochemical component, comprising an inorganic transition metal cations trap.

14. The electrochemical component of claim 13, wherein the electrochemical component is a negative electrode.

15. The electrochemical component of claim 13, wherein the electrochemical component is an electrolyte.

16. The electrochemical component of claim 13, wherein the electrochemical component is a separator.

17. The electrochemical component of claim 13, wherein the electrochemical component is a positive electrode.

18. The sodium ion battery according to claim 3, wherein the calcium phosphate is selected from the group consisting of tricalcium phosphate Ca₃(PO₄)₂, octacalcium phosphate Ca₈H₂(PO₄)₆, dicalcium diphosphate Ca₂P₂O₇, calcium triphosphate Ca₅(P₃O₁₀)₂, tetracalcium phosphate Ca(PO₄)₂O, apatite Ca₁₀(PO₄)₆(OH, F, Cl, Br)₂, hydroxyapatites (HAP) and mixtures thereof.

19. The sodium ion battery according to claim 12, wherein the transition metal cations are selected from V²⁺, V³⁺, V⁴⁺, or V⁵⁺.
